(19) United States
(12) Patent Application Publication
(10) Pub. No.: US 2017/0201480 A1
(43) Pub. Date: Jul. 13, 2017

(54) LOCATION-BASED MESSAGING

(71) Applicant: Google Inc., Mountain View, CA (US)

(72) Inventors: Frank Petterson, Mountain View, CA (US); Kathryn Cushing, San Francisco, CA (US); Sanjay Mavinkurve, Toronto (CA); Marshall Bock, San Francisco, CA (US); Randall Sarafa, San Francisco, CA (US)

(73) Assignee: Google Inc., Mountain View, CA (US)

(21) Appl. No.: 14/148,048

(22) Filed: Jan. 6, 2014

(51) Int. Cl. H04L 12/58

(52) U.S. Cl. CPC H04L 51/20; H04L 51/32

(57) ABSTRACT

A method and computing system for location-based messaging is provided. Embodiments may include associating a user with one or more computing devices and displaying, using the one or more computing devices, a user location broadcast option at a messaging application associated with the one or more computing devices. Embodiments may also include receiving, using the one or more computing devices, a selection corresponding to the user location broadcast option. Upon receiving the selection, determining a location of the one or more computing devices. Embodiments may further include displaying the location at the messaging application using at least one of the one or more computing devices.

### BACKGROUND

The Internet currently allows for the free exchange of ideas and information in a manner that was unimaginable only a couple of decades ago. One such use for the Internet is as a communication medium, whether it is via one-on-one exchanges or multi- party exchanges within social networks.

Social networks may allow for users to engage in a quasi-real-time, interactive dialogue. Included within social networks may be the ability to participate in a real-time messaging session, which may allow for one or more users to communicate using video, text or other suitable approaches.

### SUMMARY OF DISCLOSURE

In one implementation, a computer-implemented method for location-based messaging may include associating a user with one or more computing devices and displaying, using the one or more computing devices, a user location broadcast option at a messaging application associated with the one or more computing devices. Embodiments may further include receiving, using the one or more computing devices, a selection corresponding to the user location broadcast option. Upon receiving the selection, embodiments may include determining a location of the one or more computing devices. Embodiments may further include displaying the location at the messaging application using at least one of the one or more computing devices wherein displaying the location at the messaging application includes rendering a map depicting the location, the map rendered within the messaging application.

In another implementation, a computer-implemented method may include associating a user with one or more computing devices and displaying, using the one or more computing devices, a user location broadcast option at a messaging application associated with the one or more computing devices. Embodiments may also include receiving, using the one or more computing devices, a selection corresponding to the user location broadcast option. Upon receiving the selection, determining a location of the one or more computing devices. Embodiments may further include displaying the location at the messaging application using at least one of the one or more computing devices.

One or more of the following features may be included. In some embodiments, determining the location may include determining the location using a global positioning system (“GPS”). Displaying the location at the messaging application may include rendering a map depicting the location. In some embodiments, the user location broadcast option may be displayed within a thread associated with the messaging application. Displaying the location may include displaying the location at a first computing device associated with the user. Determining a location may include receiving location-based information from one or more location applications. Displaying the location at the messaging application may include displaying at least one of a city, a state, a country, and an address indicating the location. Determining the location may include receiving textual input from the user indicating the location. Displaying the location at the messaging application may include simultaneously displaying a message input field at the messaging application. Displaying the location may include displaying the location at a second computing device associated with the user's social network.

In another implementation, a computing system including a processor and memory is configured to perform operations including associating a user with one or more computing devices and displaying, using the one or more computing devices, a user location broadcast option at a messaging application associated with the one or more computing devices. Embodiments may also include receiving, using the one or more computing devices, a selection corresponding to the user location broadcast option. Upon receiving the selection, determining a location of the one or more computing devices. Embodiments may further include displaying the location at the messaging application using at least one of the one or more computing devices.

One or more of the following features may be included. In some embodiments, determining the location may include determining the location using a global positioning system (“GPS”). Displaying the location at the messaging application may include rendering a map depicting the location. In some embodiments, the user location broadcast option may be displayed within a thread associated with the messaging application. Displaying the location may include displaying the location at a first computing device associated with the user. Determining a location may include receiving location-based information from one or more location applications. Displaying the location at the messaging application may include displaying at least one of a city, a state, a country, and an address indicating the location. Determining the location may include receiving textual input from the user indicating the location. Displaying the location at the messaging application may include simultaneously displaying a message input field at the messaging application. Displaying the location may include displaying the location at a second computing device associated with the user's social network.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a location-based messaging process according to an embodiment of the present disclosure;

FIG. 2 is a flowchart of the location-based messaging process of FIG. 1 according to an embodiment of the present disclosure;

FIG. 3 is a diagrammatic view of a display screen rendered by the location-based messaging process of FIG. 1 according to an embodiment of the present disclosure;

FIG. 4 is a diagrammatic view of a display screen rendered by the location-based messaging process of FIG. 1 according to an embodiment of the present disclosure;

FIG. 5 is a diagrammatic view of a display screen rendered by the location-based messaging process of FIG. 1 according to an embodiment of the present disclosure; and

FIG. 6 is a diagrammatic view of the computing device of FIG. 1 according to an embodiment of the present disclosure.

Like reference symbols in the various drawings indicate like elements.

### DETAILED DESCRIPTION

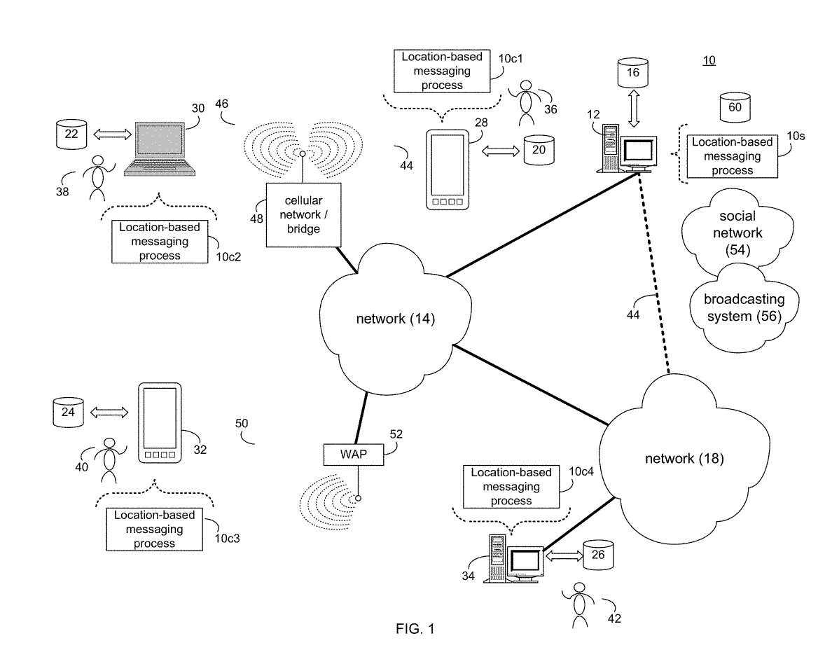

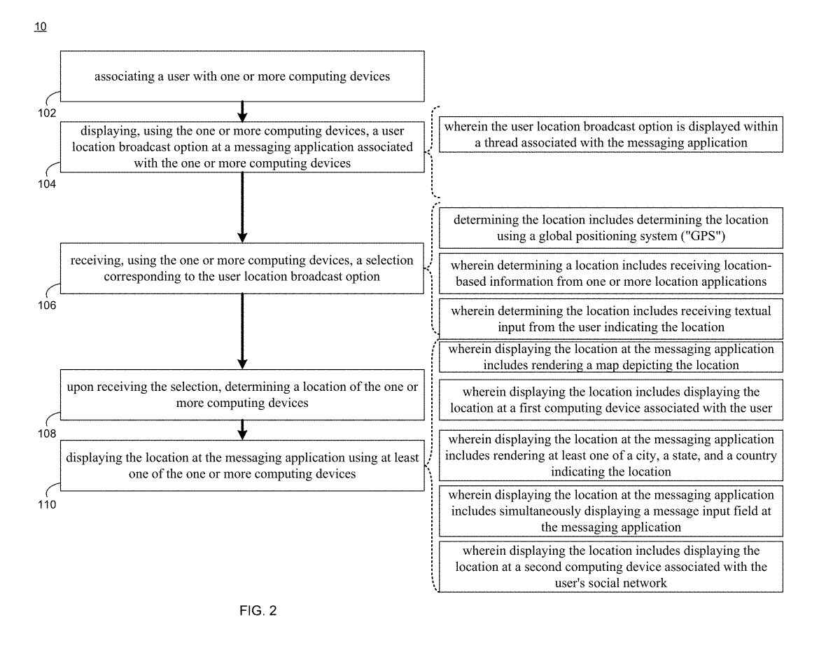

Referring now to FIGS. 1-2, there is shown a location-based messaging process 10. Location-based messaging process 10 may be implemented as a server-side process, a client-side process, or a hybrid server-side/client-side process. For example, location-based messaging process 10 may be implemented as a purely server-side process via location-based messaging process 10s. Alternatively, location-based messaging process 10 may be implemented as a purely client-side process via one or more of location-based messaging process 10c1, location-based messaging process 10c2, location-based messaging process 10c3, and location-based messaging process 10c4. Alternatively still, location-based messaging process 10 may be implemented as a hybrid server-side/client-side process via location-based messaging process 10s in combination with one or more of location-based messaging process 10c1, location-based messaging process 10c2, location-based messaging process 10c3, and location-based messaging process 10c4. Accordingly, location-based messaging process 10 as used in this disclosure may include any combination of location-based messaging process 10s, location-based messaging process 10c1, location-based messaging process 10c2, location-based messaging process 10c3, and location-based messaging process 10c4.

As will be discussed below in greater detail, location-based messaging process 10 may associate 102 a user with one or more computing devices and may display 104 a user location broadcast option at a messaging application associated with the one or more computing devices. Process 10 may receive 106 a selection corresponding to the user location broadcast option. Upon receiving the selection, process 10 may determine 108 a location of the one or more computing devices and may display 110 the location at the messaging application using at least one of the one or more computing devices.

Location-based messaging process 10s may be a server application and may reside on and may be executed by computing device 12, which may be connected to network 14 (e.g., the Internet or a local area network). Examples of computing device 12 may include, but are not limited to: a personal computer, a laptop computer, a tablet computer, a personal digital assistant, a data-enabled cellular telephone, a notebook computer, a television with one or more processors embedded therein or coupled thereto, a server computer, a series of server computers, a mini computer, a mainframe computer, smartphone or a dedicated network device.

The instruction sets and subroutines of location-based messaging process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of location-based messaging processes 10c1, 10c2, 10c3, 10c4 may include but are not limited to a web browser, a game console user interface, a social network user interface, or a specialized application. The instruction sets and subroutines of location-based messaging processes 10c1 , 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a tablet computer (not shown), a notebook computer (not shown), a server computer (not shown), a smart television (not shown), a gaming console (not shown), and a dedicated network device (not shown). Client electronic devices 28, 30, 32, 34 may each execute an operating system.

Users 36, 38, 40, 42 may access location-based messaging process 10 directly through network 14 or through secondary network 18. Further, location-based messaging process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As is known in the art, users of social networks (e.g., social network 54) may be able to participate in group communication sessions (e.g., video conferences, text-messaging applications, etc.) that may allow for virtual gatherings of people so that they may chat about various topics.

Accordingly, location-based messaging process 10 may be included within, executed within, or a portion of social network 54. Alternatively, location-based messaging process 10 may be included within, executed within, or a portion of Internet-based broadcasting system 56. Further, location-based messaging process 10 may be a stand-alone application that may be configured to interface with social network 54 and/or Internet-based broadcasting system 56. Additionally, Internet-based broadcasting system 56 may be included within, executed within, or a portion of social network 54.

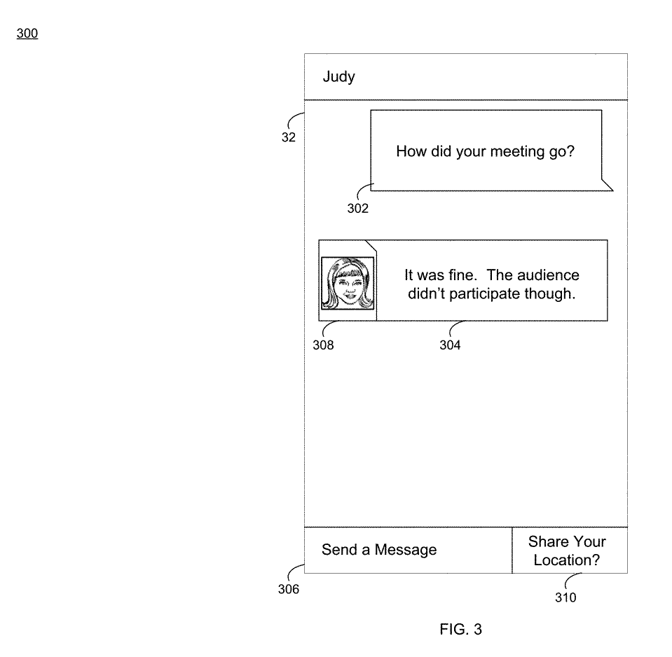

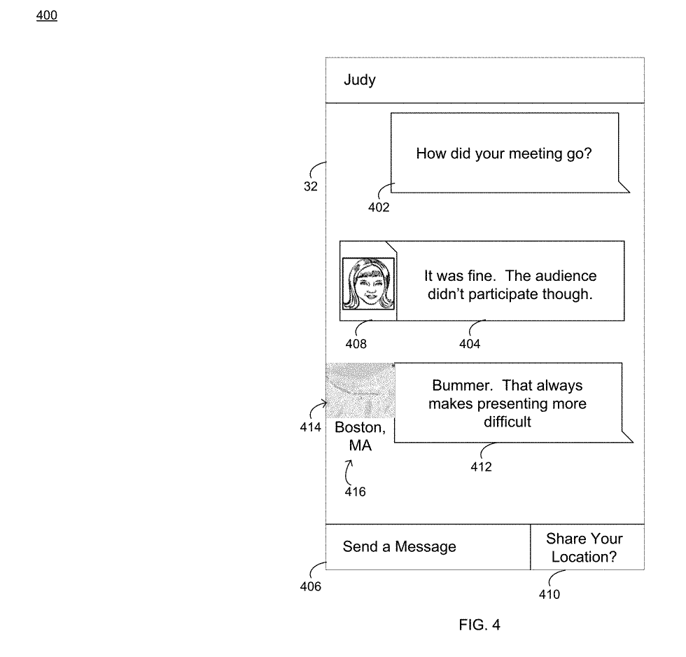

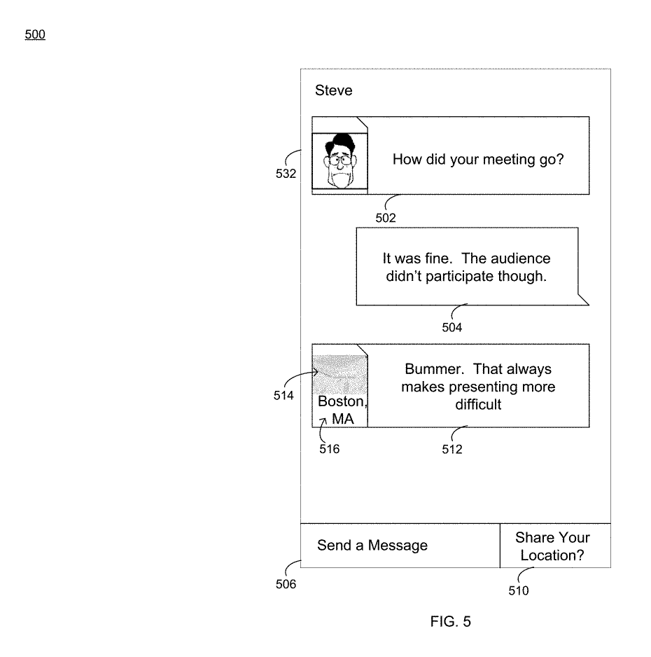

Referring also to FIG. 3, assume for illustrative purposes that user 40 (in this example, Steve) wishes to communicate with another member of his or her social network 54 (in this example, Judy). As shown in FIG. 3, user 40 may be associated with one or more computing devices, such as portable computing device 32. Accordingly, messages transmitted to/from portable computing device 32 may be associated with user 40. In some embodiments, this association may occur at server computing device 12, portable computing device 32 and/or any other suitable devices within networks 14 and 18. In the examples provided, the contact with which the user is speaking may be identified at the top of the messaging application within a user ID field (e.g. FIGS. 3-4 indicate that portable computing device 32 is associated with Steve and he is communicating with Judy). An alternative arrangement is shown in FIG. 5 (e.g. portable computing device 532 is associated with Judy and she is communicating with Steve).

As is shown in FIGS. 3-5, portable computing device 32 may have one or more messaging applications associated therewith. The messaging application may allow for communication between members of social network 54. Additionally and/or alternatively, messaging application may also allow for communication between users who may not be affiliated with social network 54. In this way, messaging application may allow for the transmission of outgoing messages (e.g. message 302) as well as for the reception messages (e.g. message 304). The messaging application may also include a message input field 306, which may allow the user to enter the text that the user may wish to transmit. In some embodiments, an image or avatar for each user may be associated with each message. For example, and as shown in FIG. 3, the particular user that is communicating with user 40 has associated a user image 308 with her outgoing messages.

In some embodiments, location-based messaging process 10 may allow for the display of a user location broadcast option 310 at the messaging application. As shown in FIG. 3, in some instances user location broadcast option 310 may be next to message input field 306. However, it should be noted, that option 310 may be provided at any suitable location within the messaging application (e.g. within a thread associated with the messaging application). Option 310 may be activated at the user's discretion as is discussed in further detail hereinbelow.

In some embodiments, and if the user desires to share his/her current location, location-based messaging process 10 may be configured to receive a selection corresponding to user location broadcast option 310. Any suitable approach may be used to activate user location broadcast option 310. For example, some activation approaches may include, but are not limited to, selecting option 310 via a touch screen interface, using a stylus, using a voice activated command, etc.

In some embodiments, upon receiving the selection, location-based messaging process 10 may be configured to determine a location of portable computing device 32. The location of portable computing device 32 may be achieved using any suitable technique. For example, in some cases global positioning system (“GPS”) functionality may be employed to determine the actual location of portable computing device 32 associated with user 40. In some embodiments, location-based messaging process 10 may be configured to receive location-based information from one or more location applications (e.g. one or more map applications associated with portable computing device 32 and/or accessible via network 14).

Referring also to FIG. 4, once location-based messaging process 10 has determined the location of portable computing device 32 this location may be shared with the other participants in the messaging application. Accordingly, location-based messaging process 10 may be configured to display the user's location (e.g. 414, 416) at the messaging application. In the example shown in FIG. 4, location-based messaging process 10 may be configured to generate and/or render a map 414 depicting the determined location. In some embodiments, map 414 may be positioned next to one or more messages (e.g. incoming message 412). Map 414 may be in communication with one or more location applications and may be user-selectable (e.g. in the event that a user wishes to enlarge the image, etc.). Further, map 414 may be located in any suitable position within the messaging application.

In some embodiments, location-based messaging process 10 may be configured to generate textual information corresponding to a user's location. This textual information may be automatically or manually generated. For example, and as shown in FIG. 4, text-based location information may be automatically generated using the location application in certain embodiments. Additionally and/or alternatively, this information (e.g. “Boston, Mass.”) may be entered by the user (e.g. user 40 enters his/her location). In some implementations, location-based messaging process 10 may be configured to generate city, state, country, store, venue, and/or address information, etc, and to display that information within messaging application.

In some embodiments, additional functionality and options regarding user location broadcast option 410 may be provided. As such, the user may choose to display any combination of map 414 and text 416. For example, the user may wish to display only map 414 or only text 416. These options may be provided to the user via the graphical user interface associated with portable electronic device 32 (e.g. in the device settings, or via a pop-up or other display that may be activated upon selecting location broadcast option 410.

As shown in FIGS. 3-4, in some embodiments location-based messaging process 10 may be configured to display the location at a first computing device associated with the user (e.g. portable computing device 32 associated with user 40, in this example Steve). Additionally and/or alternatively, and referring to FIG. 5, location-based messaging process 10 may also be configured to display the location at a second computing device associated with the user's social network (e.g. portable computing device 532, in this example associated with Judy).

In some embodiments, and as shown in FIGS. 3-5, displaying the location at the messaging application may include simultaneously displaying both user location broadcast option 510 and message input field 506 at the messaging application. Additionally and/or alternatively, user location broadcast option 510 may be hidden before or after selection, at the user's discretion. In some embodiments, selecting location broadcast option may result in the display of the location information next to message input field 506, for example, within the field associated with user location broadcast option 510. In some implementations, the display of location information may also be associated with the user ID field (e.g. Judy's location information may be located next to her name within the user ID field so that Steve may identify both her name and location more readily).

In some embodiments, location-based messaging process 10 may be configured to display a list of possible locations within the messaging application. For example, the map application may provide a plurality of possible results based upon the location determination discussed above. In this particular example, and based upon the map application results, location-based messaging process 10 may determine that the user is either in a restaurant or the clothing store next door. In this way, location-based messaging process 10 may display these options to the user and may allow the user to select the appropriate option.

In some embodiments, location information may be obtained via network 14 and may be provided from one or more computing devices associated with the network (e.g. server computing device 12. Additionally and/or alternatively, location information may be obtained directly from the portable computing device (e.g. portable computing device 32).

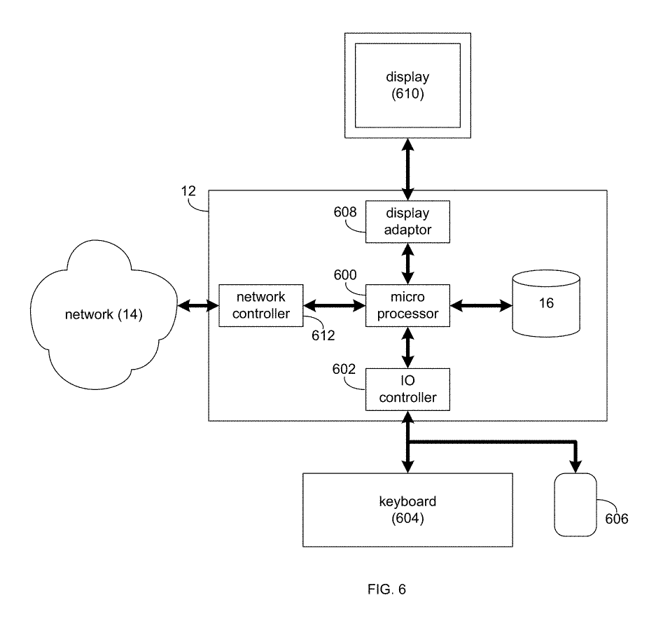

Referring also to FIG. 6, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, location-based messaging process 10 may be substituted for computing device 12 within FIG. 6, examples of which may include but are not limited to client electronic devices 28, 30, 32, 34.

Computing system 12 may include microprocessor 600 configured to e.g., process data and execute instructions/code for location-based messaging process 10. Microprocessor 600 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 602 may be configured to couple microprocessor 600 with various devices, such as keyboard 604, mouse 606, USB ports (not shown), and printer ports (not shown). Display adaptor 608 may be configured to couple display 610 (e.g., a CRT or LCD monitor) with microprocessor 600, while network adapter 612 (e.g., an Ethernet adapter) may be configured to couple microprocessor 600 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C⁺⁺ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 600) of a general purpose computer/special purpose computer/other programmable data processing apparatus (e.g., computing device 12), such that the instructions, which execute via the processor (e.g., processor 600) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having described the disclosure of the present application in detail and by reference to embodiments thereof, it will be apparent that modifications and variations are possible without departing from the scope of the disclosure defined in the appended claims.

1. (canceled)

2. A computer-implemented method comprising:
associating a user with one or more computing devices;
displaying, using the one or more computing devices, a user location broadcast option at a messaging application associated with the one or more computing devices;
receiving, using the one or more computing devices, a selection corresponding to the user location broadcast option;
determining a location of the one or more computing devices;
in response to determining the location, displaying a list of possible location options based on the location;
receiving a selection of a particular location option from the list of possible location options; and
transmitting the particular location option to another computing device associated with another user via the messaging application using at least one of the one or more computing devices, wherein the particular location option is displayed in a user ID field of the messaging application of the other computing device.

3. The computer-implemented method of claim 2 wherein determining the location includes determining the location using a global positioning system (“GPS”).

4. The computer-implemented method of claim 2 wherein the particular location option is displayed in the user ID field of the messaging application by rendering a map depicting the particular location option.

5. The computer-implemented method of claim 2 wherein the user location broadcast option is displayed within a thread associated with the messaging application.

6. (canceled)

7. The computer-implemented method of claim 2 wherein determining a location includes receiving location-based information from one or more location applications.

8. The computer-implemented method of claim 2 wherein the particular location option is displayed in the user ID field of the messaging application by displaying at least one of a city, a state, a country, and an address indicating the particular location option.

9. The computer-implemented method of claim 2 wherein determining the location includes receiving textual input from the user indicating the location.

10. (canceled)

11. (canceled)

12. A computing system including a processor and memory configured to perform operations comprising:
associating a user with one or more computing devices;
displaying, using the one or more computing devices, a user location broadcast option at a messaging application associated with the one or more computing devices;
receiving, using the one or more computing devices, a selection corresponding to the user location broadcast option;
determining a location of the one or more computing devices;
in response to determining the location, displaying a list of possible location options based on the location;
receiving a selection of a particular location option from the list of possible location options; and
transmitting the particular location option to another computing device associated with another user via the messaging application using at least one of the one or more computing devices, wherein the particular location option is displayed in a user ID field of the messaging application of the other computing device.

13. The computing system of claim 12 wherein determining the location includes determining the location using a global positioning system (“GPS”).

14. The computing system of claim 12 wherein the particular location option is displayed in the user ID field of the messaging application by rendering a map depicting the particular location option.

15. The computing system of claim 12 wherein the user location broadcast option is displayed within a thread associated with the messaging application.

16. (canceled)

17. The computing system of claim 12 wherein determining a location includes receiving location-based information from one or more location applications.

18. The computing system of claim 12 wherein the particular location option is displayed in the user ID field of the messaging application by displaying at least one of a city, a state, a country, and an address indicating the particular location option.

19. The computing system of claim 12 wherein determining the location includes receiving textual input from the user indicating the location.

20. (canceled)

21. (canceled)

22. The computer-implemented method of claim 2 wherein the user location broadcast option includes a list of display options, the list of display options including a map display option and a text display option.

23. The computer-implemented method of claim 22 further comprising receiving a selection of a particular display option from the list of display options, wherein the particular location option is displayed in the user ID field of the messaging application of the other computing device in accordance with the selected particular display option.

24. The computer-implemented method of claim 22 wherein the list of display options further includes a combination map and text display option.

25. The computing system of claim 12 wherein the user location broadcast option includes a list of display options, the list of display options including a map display option and a text display option.

26. The computing system of claim 25 wherein the operations further comprise receiving a selection of a particular display option from the list of display options, wherein the particular location option is displayed in the user ID field of the messaging application of the other computing device in accordance with the selected particular display option.

27. The computing system of claim 25 wherein the list of display options further includes a combination map and text display option.
